(19) United States
(12) Patent Application Publication
(10) Pub. No.: US 2010/0005748 A1
(43) Pub. Date: Jan. 14, 2010

(54) Deck Covering

(75) Inventors: Douglas A. Cahill, Belcher Town, MA (US); Richard S. Himmelwright, Wilbraham, MA (US); John P. McCue, Holyoke, MA (US)

Correspondence Address: CROWELL & MORING LLP;INTELLECTUAL PROPERTY GROUP, P.O. BOX 14300, WASHINGTON, DC, 20044-4300, US

(73) Assignee: Cold Spring Technology, Inc., Three Rivers, MA (US)

(21) Appl. No.: 12/563,859

(22) Filed: Sep. 21, 2009

Related U.S. Application Data
(63) Continuation of application No. 11/274,090, filed on Nov. 16, 2005, now abandoned.
(60) Provisional application No. 60/627,970, filed on Nov. 16, 2004.

(51) Int. Cl. E04B 5/00; B29C 73/00

(52) U.S. Cl. 52/578; 264/36.1

(57) ABSTRACT

Provided is a system and method for protecting and restoring a surface by applying thereto a preformed polymer based film and securing the film to the surface. Particular application is found where the surface is a deck surface.

### CROSS REFERENCE TO RELATED APPLICATION

The present application is a Continuation of U.S. application Ser. No. 11/274,090, filed Nov. 16, 2005, which is incorporated herein in its entirety which claims priority to Provisional U.S. Application No. 60/627,970, filed Nov. 16, 2004, which is incorporated by reference herein in its entirety.

### BACKGROUND OF THE INVENTION

The present invention relates to a system for covering wood decking and other surfaces that provides a durable final finish. It also relates to a method of manufacturing an ideal polymer covering material and a method of application of the covering material.

Wood structures are prone to deterioration by weather, ultraviolet rays in sunlight and abrasion from traffic and the like. Commercial wood replacement materials that have improved weathering durability are expensive and the refurbishment of existing wood decking with these synthetic substitutes is both expensive and complicated. There are many types of coatings that have been developed to slow the deterioration of wood structures and improve the appearance of deteriorated wood. Most of these coatings are applied in the liquid state via brushing or using spraying equipment. Many of these coatings are applied from solvent based formulations and thus generate large amounts of VOC (volatile organic compounds) that are released into the atmosphere upon drying. In addition, when the wood of a deck surface or other structure has been significantly deteriorated the typical coatings available cannot return the deck surface to a high quality appearance Expansion and contraction of wood relative to ambient moisture conditions leads to wood splitting, chipping and splintering. Conventional thin polymer coatings that are applied to achieve water repellency often fail in use as a consequence of the woods' expansion and contraction caused by ambient moisture changes. Therefore, there exists a need for an alternative to the prevalent coating approach to restoring and preserving wood deck surfaces.

### SUMMARY OF THE INVENTION

The present invention relates to the restoration and protection of wood and other surfaces through the application of a preformed polymer film that can be readily applied to the desired surface. The preformed polymer film is manufactured in rolls. The preformed polymer film as pre-slit rolls are applied to the surface with adhesive and the edges are uniformly held in place with specially designed channels. The adhesive used can either be a permanent adhesive or a temporary adhesive. The temporary adhesive could be used in situations where it is desirable to change the deck covering material for special events, seasonal events or some other reason.

The deck covering preformed polymer film must have superior weather resistance, abrasion resistance, elasticity, and UV resistance. The preformed polymer film of the present invention can be polyurea, polyurethane, hybrid polyurea-polyurethane or other outdoor durable materials like but not limited to the vinyl family of polymers.

### BRIEF DESCRIPTION OF THE FIGURES OF THE DRAWING

FIG. 1a-d show the deck covering of the present invention as it is installed.

FIG. 2 shows a close up of one design of the locking channel.

FIG. 3 shows the slot dye coating manufacturing process for making the deck covering preformed films.

### DESCRIPTION OF THE PREFERRED EMBODIMENTS

Polyureas are well known, and are often classified as a heterochain macromolecular compound which contains urea groups in its structure. Polyurethanes are also well known, and include materials that incorporate the carbamate function group as well as other functional groups such as ester, amide ether and urea. Commerical polyureas and polyurethanes are well known, which are used as films and coatings. Any such polyureas and/or polyurethanes can be used and imprinted in accordance with the present invention.

In a preferred embodiment, the polyurethane/polyurea protective film or substrate/surface is produced by reacting an isocyanate with a polyol in the presence of a diamine or triamine. Preferably, the diamine or triamine is aliphatic and of low moleculare weight. The polyol is preferably a polyester polyol, a polyether polyol or an acrylic polyol. The reaction is also preferably run in the presence of a catalyst, e.g., a tin, zirconium or bismuth based catalyst.

The basic polyurea/polyurethane chemistry has been shown to yield excellent physical properties in spray applied applications and brush applied applications. The system of the present invention will allow much less skilled technicians to easily install the preformed polyurea/polyurethane deck covering. In addition, the use of complicated commercial spray equipment is eliminated with this system.

While one of the primary applications envisioned for the polyurea and/or polyurethane based preformed pre-slit panels is protecting and restoring wooden decking the material can be used on virtually any surface in need of upgrade. Walls, ceilings, exterior and interior building panels, structural steel and the like will benefit from application of the deck covering material.

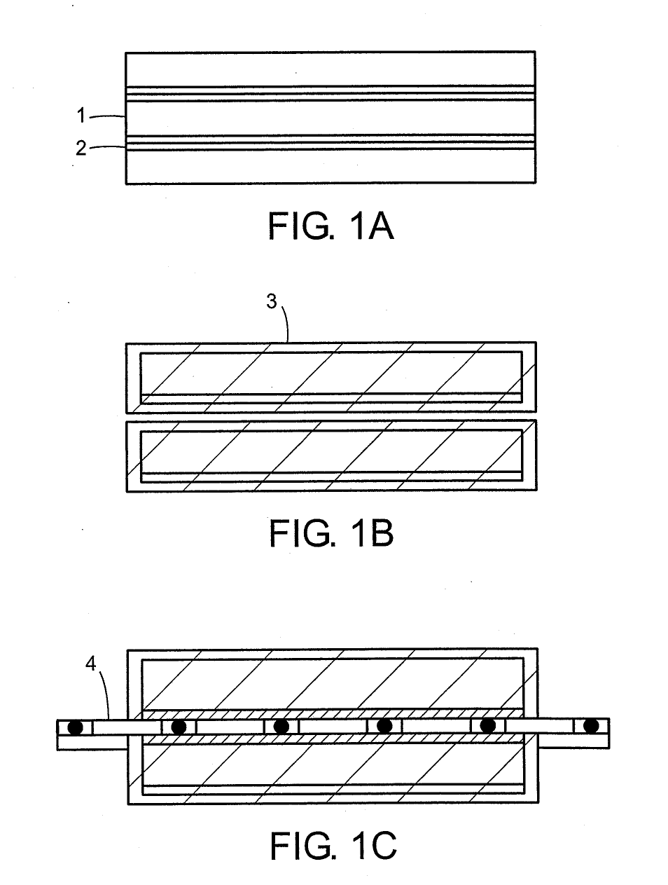

The deck covering material ideally will be manufactured in widths appropriate for typical standard lumber dimensions such that enough excess panel material will be available for wrapping over the edge of individual boards on a deck. For typical 5/4 decking which is 5.5 inches wide nominally a roll of deck cover will be produced at approximately 7.5 inches wide. The deck cover will be laid out and any trimming that is necessary can be accomplished prior to applying the adhesive. The adhesive is then applied to the area the deck cover is placed over and the deck cover is put in position. The next board is then also covered in the same manner. The overlap material is placed down into the groove between the boards. The channel is then pressed into the groove and secured with the pressure from the tapered channel edge applying pressure to assure a neat final finish. FIG. 1 shows the step by step application of the polyurea deck cover system.

In FIG. 1a, 5/4 decking 1, 5½ inches wide are laid out with gaps 2 ranging from ¼ to ½ inch. In FIG. 1b, a polyurea/polyurethane film 3 is layered over the deck boards, which are held in place with a non-aggressive, repostionable adhesive. FIG. 1e shows channel strips 4 pushed into the gaps between the deck boards. In such a case, screw clips can be used, e.g., at an interval of every 16 inches, to hold the channel and edges in place. FIG. 1d shows the channel end view and the channel screw section in more detail.

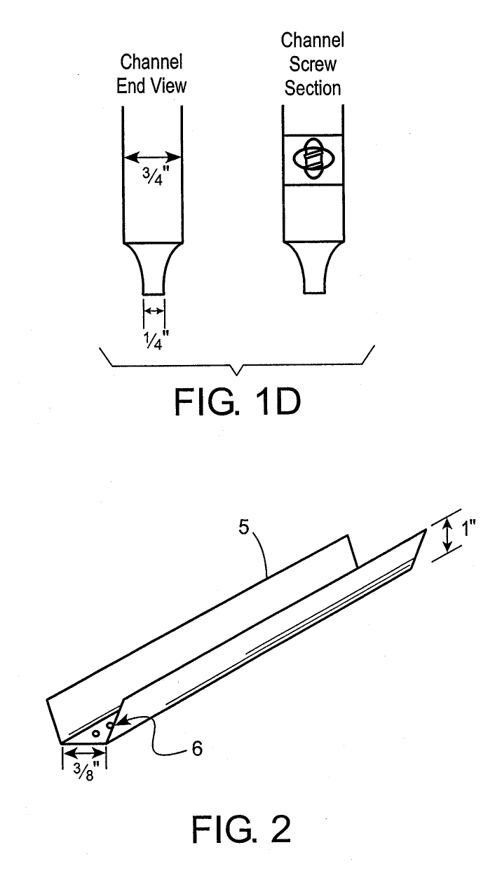

In FIG. 2, a preferred embodiment of a channel/gap fastener is shown. This particular channel strip 5 is simply pushed down into the gap and preferably screwed down to secure its position. Water drainage holes 6 are present in the channel fastener. Also, the outward force of the channel fastener holds the film against the sides of the deck boards.

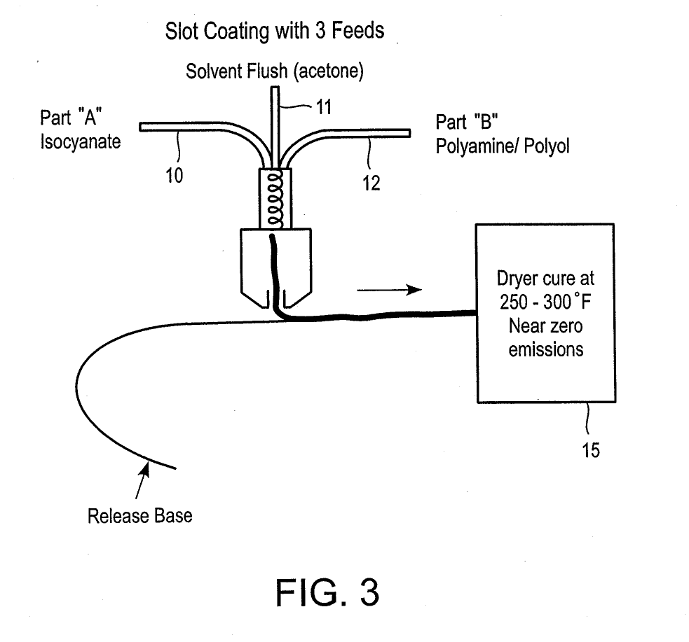

In FIG. 3, a slot dye coating manufacturing process is depicted for making deck covering preformed films. Three feeds to the slot dye are used, i.e., the isocyanate feed 10, the solvent flush 11, and the polyamine/polyol feed 12. The isocyanate and polyamine/polyol are fed through the dye and begin to react. The reactant mixture is cast onto a release base and then passed into a curing oven 15 to effect completion of the reaction and curing of the polyurea/polyurethane polymer. The curing oven is often run at a sufficient temperature to effect the cure, but is generally kept in the temperature range of from 250-300° F. The temperature may vary based upon residence time in the oven. Near zero emissions are realized from the oven.

A relatively slow cure material is preferably used, whether it is by choice of reactants or catalyst. The choice is made in order to effect an accelerated cure in the curing oven. The solvent flush, using any suitable organic solvent, e.g., acetone, is generally activated immediately when the isocyanate and polyamine/polyol feeds are stopped, in order to prevent curing of residual material in the die.

The preformed polyurea based deck cover can be produced on coating machines similar to those used in the manufacture of photographic films. The polyurea based film is made from a two component mixture that is mixed just prior to casting onto a carrier/release sheet. The polyurea based film is then peeled off the carrier sheet and rolled up into rolls and pre-slit for final use.

Conversely, the polyurea based deck cover material can also be produced by spraying via spray equipment. Equipment for example manufactured by Glas-Craft or Gussmer can be used.

The locking channel can be made from materials such as but not limited to polyvinyl chloride, polyurea, polyurethane and the like. Typical extrusion equipment can be used to manufacture the locking channel.

### EXAMPLE

A polyurea deck cover sheet is manufactured by controlled spray application of a two component system via a Glas-Craft MIX unit. The preformed polyurea film of approximately 2 mM thickness is then peeled off the release sheet and cut into 7.5 inch wide strips. The 5/4 wood decking to be covered is then coated with a high strength adhesive. The deck cover strips are then laid in place and the overlap material tucked into the gap between the boards. Finally, the locking channel is pressed between the boards and yields a neat trim finish. The polyurea based film of this example is manufactured according to the following formula;

Part A Isocyanate: 50 parts Bayer N3400/50 parts ARCPP-100

Part B Polyamine; 50 parts Clearlink 1000/50 parts ARCdiamirie-100

Spray unit pressure of 2200 psi, temperature of 170° C. for Part A, 150° C. for Part B

While the preferred embodiments of the invention have been disclosed in detail, other embodiments within the described invention obvious to those skilled in the art are considered to be part of the present invention and are intended to be included in the claims below.

What is claimed is:

1. Method for protecting and restoring adjacent surfaces by applying thereto a preformed polymer based film and securing the film to the surface, and inserting a preformed locking channel in between the adjacent surfaces to provide a neat finish to the edges of the individual adjacent surfaces.

2. The method of claim 1, wherein the locking channel has tapered sides made of firm but flexible material such that the channel can be pushed in place for final installation.

3. The method of claim 1, wherein the locking channel has drain holes.

4. The method of claim 1, wherein the polymer based film is a polyurea, a hybrid polyurea/polyurethane, a polyurethane, a vinyl, a polypropylene, an acrylic or polyethylene polymer.

5. The method of claim 1, wherein the film thickness is in the range of 0.1 mM to 10 mM.

6. The method of claim 1, wherein the polymer based film is prepared by slot dye coating on a carrier release sheet.

7. The method of claim 1, in which the preformed polymer film has a textured surface.

8. The method of claim 1, wherein the surface is a deck surface.

9. A deck comprised of individual adjacent surfaces having grooves between the adjacent surfaces, with the adjacent surfaces having a preformed polymer based film secured to each individual surface and with a locking channel in the grooves to provide a neat finish to the edges of the surfaces.
